(19) United States
(12) Patent Application Publication
(10) Pub. No.: US 2010/0102131 A1
(43) Pub. Date: Apr. 29, 2010

(54) Systems and Methods for Disabling a Contactless Transaction Device

(75) Inventor: Daniel P. Skowronek, Parker, CO (US)

Correspondence Address: SUTHERLAND ASBILL & BRENNAN LLP, 999 PEACHTREE STREET, N.E., ATLANTA, GA, 30309, US

(73) Assignee: First Data Corporation, Greenwood Village, CO (US)

(21) Appl. No.: 12/259,491

(22) Filed: Oct. 28, 2008

(51) Int. Cl. G06K 19/067

(52) U.S. Cl. 235/492; 29/600

(57) ABSTRACT

Certain embodiments of the invention can provide systems and methods for disabling a contactless transaction device. In one example embodiment, a contactless transaction device operable to facilitate an electronic transaction is provided. The device may include a body, a microchip integrated with the body, and an antenna integrated with the body and in communication with the microchip. The body may include destruction indicia to indicate at least one position on the body to receive a force to disable use of the contactless transaction device for facilitating an electronic transaction.

### TECHNICAL FIELD

The invention relates generally to contactless transaction devices, and more particularly to systems and methods for disabling contactless transaction devices.

### BACKGROUND OF THE INVENTION

Transaction cards, such as credit cards, debit cards, ATM cards, bank cards, etc., are increasingly replacing other types of tender in consumer transactions. In addition, vendors and merchants are issuing different types of transaction cards, such as loyalty cards, gift cards, stored valued cards, etc., for sales promotions and the cultivation of customer loyalty. Various transaction cards may also be used for gaining access to buildings, systems, or to provide other authentication schemes. Recently there has been a movement toward contactless transaction cards and other devices that initiate and complete a transaction with a quick wave of a card before a radio frequency enabled or other wireless enabled terminal reader. Many loyalty card, gift card, and stored value card issuers, and many major credit card companies now offer contactless transaction devices, and many merchants have installed radio frequency enabled readers to facilitate such contactless electronic transactions.

With the increasing use of contactless transaction cards and other devices, consumers inevitably have an increasing amount of information stored and/or associated with the device. However, incidents of fraud, information theft, identity theft, online fraud, etc., are also increasing as consumers more commonly rely on these types of transaction devices. Because some contactless transaction devices, such as prepaid or stored value contactless cards, serve as bearer instruments without requiring additional authentication of the user, it becomes relatively easier to use another's card without their permission to exploit the stored or accessible information or to conduct unauthorized transactions.

Accordingly, a need exists for systems and methods for disabling a contactless transaction device so the device cannot be used to facilitate contactless electronic transactions.

### SUMMARY OF THE INVENTION

Embodiments of the invention can provide some or all of the above needs. Certain embodiments of the invention can provide systems and methods for disabling a contactless transaction device. In one example embodiment, a contactless transaction device operable to facilitate an electronic transaction is provided. The device may include a body, a microchip integrated with the body, and an antenna integrated with the body and in communication with the microchip. The body may include destruction indicia to indicate at least one position on the body to receive a force to disable use of the contactless transaction device for facilitating an electronic transaction.

According to various aspects of the invention, the destruction indicia may include some or all of the following: a solid or broken line across at least a portion of at least one of the position of the microchip in the body or the position of the antenna in the body, instructions to apply the force along the solid or broken line, a solid or broken line indicating an approximate location of at least a portion of the microchip in the body, instructions to apply the force at an approximate location of at least a portion of the microchip in the body, a solid or broken line indicating an approximate location of at least a portion of the antenna in the body, instructions to apply the force at an approximate location of at least a portion of the antenna in the body, scoring of the body across at least a portion of at least one of the position of the microchip in the body or the position of the antenna in the body, and/or instructions to break the body by applying the force at the scoring.

According to another example embodiment, a method for manufacturing a destructible contactless transaction device operable to facilitate an electronic transaction is provided. The method may include providing at least one lower layer of a body of the contactless transaction device, providing at least one upper layer of the body of the contactless transaction device, disposing a microchip and an antenna in communication with the microchip between the at least one lower layer and the at least one upper layer, and applying destruction indicia to indicate at least one position on the body to receive a force to disable use of the contactless transaction device for facilitating an electronic transaction.

According to yet another example embodiment, a method of disabling a contactless transaction device is provided. The method may include applying a force to at least one position indicated by the destruction indicia to disable use of the contactless transaction device for facilitating an electronic transaction.

According to one aspect of the invention, the method of disabling the contactless transaction device may further include placing the contactless transaction device in proximity to a contactless transaction device reader after applying the force to verify that the contactless transaction device is inoperable.

Other systems and methods according to various embodiments of the invention will become apparent with respect to the remainder of this document.

### BRIEF DESCRIPTION OF DRAWINGS

Having thus described embodiments of the invention in general terms, reference will now be made to the accompanying drawings, which are not drawn to scale, and wherein:

FIGS. 1A-1E illustrate plan views of example contactless transaction devices, according to embodiments of the invention;

FIGS. 2A-2J illustrate plan views of example contactless transaction devices including destruction indicia thereon, according to embodiments of the invention;

FIG. 3 illustrates an exploded plan view of an example contactless transaction device including destruction indicia thereon, according to one embodiment of the invention;

FIG. 4 illustrates an example flowchart of an example method, according to one embodiment of the invention;

FIG. 5 illustrates an example flowchart of an example method, according to one embodiment of the invention;

FIG. 6 illustrates an example flowchart of an example method, according to one embodiment of the invention; and

FIG. 7 illustrates an example flowchart of an example method, according to one embodiment of the invention.

### DETAILED DESCRIPTION OF EMBODIMENTS OF THE INVENTION

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention. Like numbers refer to like elements throughout.

As used herein, the term “contactless transaction device” can refer to any transaction device operable to conduct an electronic transaction using wireless communication protocol. An example “contactless transaction device” may be, but is not limited to, a radio frequency identification device including an integrated circuit chip connected to an antenna or wireless transmitter and/or receiver. An example “contactless transaction device” may use other wireless communication protocol may be used, such as Bluetooth, infrared, and the like. Example electronic transactions may include commercial transactions at a merchant point of sale terminal, such as by a credit card, debit card, gift card, or stored value card, loyalty transactions, automatic teller machine transactions, and the like.

As used herein, the terms “body” may be used to refer to any assembly that includes hardware and/or software components for conducting contactless transactions. A “body” may otherwise be referred to as a “form factor.” Example “bodies” may be, but are not limited to, a card, a wristband, another wearable article, a fob or keychain, a sticker, and the like.

As used herein, the term “force” may refer to any force that may be applied to a contactless transaction device by a machine or by an individual. An example “force” may include, but is not limited to, a cutting force, a bending force, a deforming force, a twisting force, a lateral force, a longitudinal force, a tearing force, or any combination thereof.

As used herein, the term “destruction indicia” may refer to any marking, printing, embossing, scoring, perforation, disconfiguration, written instructions, and the like, that indicate one or more positions on the body of a contactless transaction device to apply a force when disabling or otherwise destroying the contactless transaction device.

Certain embodiments of the invention generally provide for systems and methods for disabling a contactless transaction device. Example systems and methods can provide a contactless transaction device having a body, and a microchip and antenna (or an antenna and an induction loop) integrated with the body. The body may include destruction indicia to indicate at least one position on the body to receive a force to disable use of the contactless transaction device for facilitating an electronic transaction. The destruction indicia may include a solid or broken line graphically printed, embossed, or otherwise applied to the body across a portion of the position of the microchip and/or a position of the antenna, such that when a force is applied at the solid or broken line, the force would destroy or otherwise disable the operability of the microchip and/or the antenna, disabling the use of the contactless transaction device for facilitating electronic transactions. In other example embodiments, a solid or broken line may indicate the position of the microchip and/or the antenna, thus indicating to a user where on the contactless transaction device the operable hardware is that can be destroyed by applying a force. In yet another example embodiment, the destruction indicia may be formed by physically scoring the body of the contactless transaction device across at least a portion of the position of the microchip and/or the antenna. Scoring will facilitate the destruction of the device body at the desired positions so as to effectively disable the microchip and/or antenna. Other destruction indicia may include graphic illustrations or written instructions graphically printed, embossed, or otherwise applied that illustrate and/or instruct a user how to disable the use of the contactless transaction device for facilitating electronic transactions, such as how and/or where to apply a disabling force. Graphic illustrations or written instructions may exist alone on a contactless transaction device, or may be applied in conjunction with one or more of the other destruction indicia described herein.

Other embodiments provide for methods for manufacturing a contactless transaction device having destruction indicia thereon. For example, when scoring a body of a contactless transaction device, the scoring may be performed prior to disposing the microchip and antenna within the body,.so as to not damage the hardware during manufacturing. In another example, destruction indicia may be printed, impregnated, or otherwise graphically applied at any stage of manufacturing the device, including after the microchip and antenna are disposed within the body.

Methods are also described for disabling a contactless transaction device having destruction indicia, and subsequently testing the operability of the device to facilitate an electronic transaction. For example, a contactless transaction device having a body including destruction indicia may be subjected to a disabling force applied at or near a position on the body indicated by the destruction indicia. Applying the force should disable, damage, destroy, or otherwise render the hardware, such as the microchip and/or the antenna, inoperable to facilitate an electronic transaction. The inoperability of the contactless transaction device may further be tested by placing the contactless transaction device in proximity to a contactless transaction device reader after applying the force. Typical contactless transaction device readers provide visual and/or audible indication of successful wireless communication with the contactless transaction device. Thus, if the contactless transaction device is effectively disabled, no audible, visual, and/or any other indication of successful communication from the reader is expected.

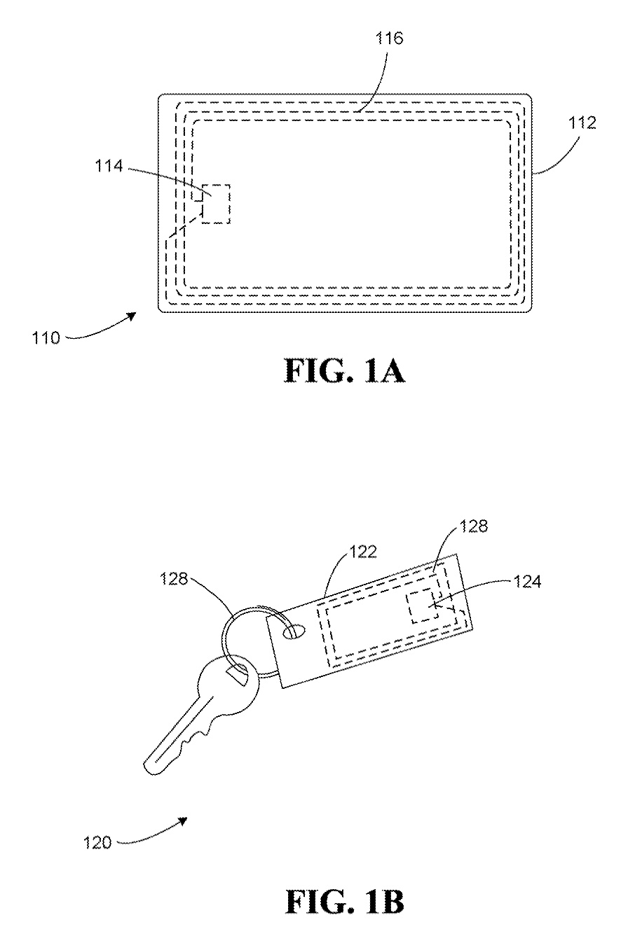

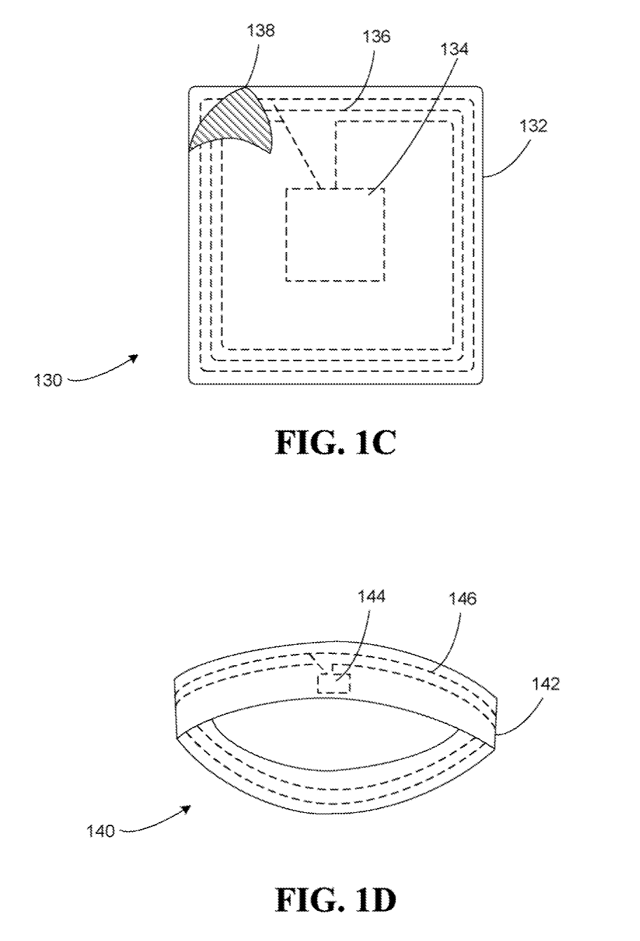

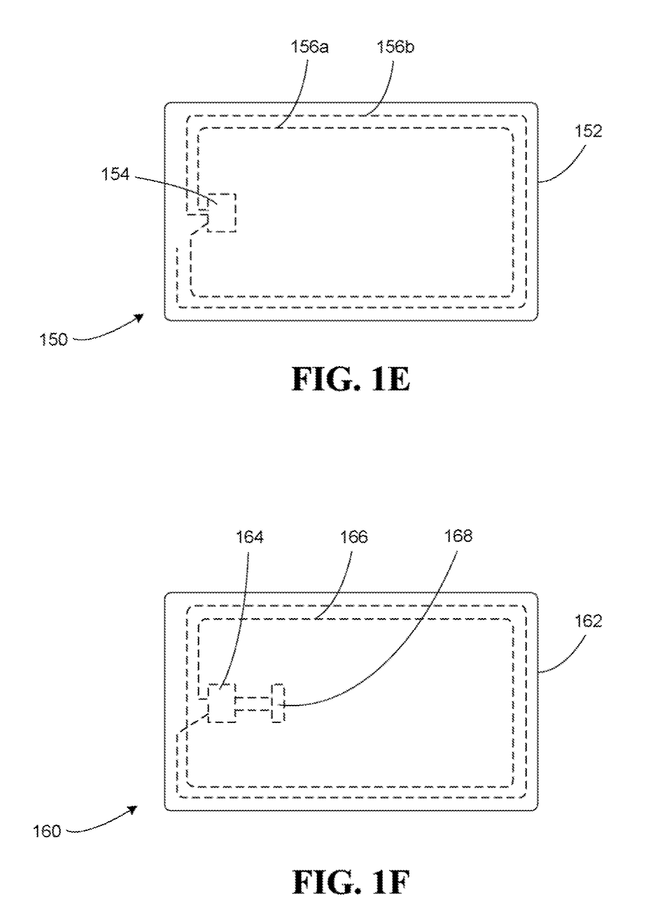

FIGS. 1A-1D illustrate example embodiments of contactless transaction devices in accordance with embodiments of the invention, without indicating the destruction indicia, as further described and illustrated herein with reference to subsequent figures. For example, FIG. 1A shows a contactless transaction device 10 generally embodied as having a shape and dimensions similar to a typical credit card, for example, approximately 3.375 inches (85.725 mm) by 2.125 inches (53.975 mm) by 0.03 inches (0.762_mm). The contactless transaction device 110 includes a body 112 providing an assembly or substrate for the contactless transaction device and housing the hardware. The body 112 may be constructed of plastic, vinyl, polyvinyl chloride, other polymers, paper, and/or other suitable materials for providing a rigid, semi-rigid, or flexible assembly to house the hardware and for convenient use and storage of the contactless transaction device 110. While FIG. 1A illustrates the body 112 having a shape similar to a credit card, in other embodiments the body 112 may have a non-standard shape and dimension. The contactless transaction device 110 further includes at least one integrated circuit microchip 114 and at least one antenna 116 or wireless transmitter and/or receiver, for transmitting and/or receiving information associated with a wireless electronic transaction. The microchip 114 and antenna 116 are typically disposed within the body 112, such as laminated or molded between two or more sheets of plastic. In many embodiments, the microchip 114 and antenna 116 are not visible without deconstructing the card, as is illustrated by broken lines indicating the position of the microchip 114 and the antenna 116 within the body 112, but not necessarily indicating that the microchip 114 and the antenna 116 are disposed on the surface of the body 112 or otherwise visible. In many example embodiments, the body 112 may include additional indicia (not shown), such as account information, logos, trademarks, service marks, cardholder information, instructional information, legal information, and the like. The additional indicia may be displayed on the upper (front) and/or lower (back) faces of the body 112, as is typically displayed on similar transaction devices.

The integrated circuit microchip 114 and antenna 116 may include circuitry operable to communicate electronic transaction details to a terminal via a contactless reader or another radio frequency-enabled communication device, such as tender to a merchant point of sale terminal. The microchip 114 may have an associated memory and store transaction information for a credit card, debit card, cash card, stored value card, gift card, checking account, bank account, automatic teller machine card, or loyalty card, for example. In some embodiments, the microchip 114 may also communicate authentication information, building access, event access, ticketing information, coupon information, and the like. In other embodiments, the microchip 114 may also or alternatively store security information, such as a PIN, a biometric indicator, a password, digital photograph, encryption, token key data, or other security data. The microchip 114 may also be programmable such that information may be changed by the user, for example, through a computer radio frequency interface, a merchant at a point of sale terminal, and/or another radio frequency communication device. In example embodiments, the microchip 114 may be designed to conform to one or more standards, such as ISO/IEC standards for contactless transaction cards and proximity cards, including the ISO/IEC 14443 standard and/or the ISO/IEC 15693 standard, among others.

The antenna 116 may receive information from a radio frequency-enabled contactless transaction device reader, another radio frequency-enabled communication device, and/or a device. In example embodiments where the contactless transaction device 110 is a passive radio frequency identification device, radio frequency-enabled devices, including radio frequency readers, may provide power to or otherwise energize the microchip 114 via the antenna 116 by induction or via a separate induction loop. In one example embodiment, the antenna 116 both receives signals from a contactless transaction device reader, which may also energize the microchip 114, and transmits signals from the microchip 114 to a contactless transaction device reader. In other embodiments, however, a separate induction loop may be included with the antenna 116, to receive signals form a contactless transaction device reader and to energize the microchip 114. For simplicity, “antenna” as used herein may refer to an antenna, an induction loop, and/or both an antenna and induction loop. In other embodiments, the contactless transaction device 110 may be an active or semi-active device, including a battery or other power source, such as a solar cell, for example, to power the microchip independent of signals received from a transaction terminal.

The antenna 116 may also then communicate transaction information from the microchip 114 to a radio frequency-enabled transaction device reader or another radio frequency-enabled communications device. The antenna 116 may use any wireless communication methodology and may communicate via radio frequencies. Furthermore, in example embodiments, the information transmitted by the contactless transaction device 110 may conform to one or more specifications for credit or debit cards, for example, PayPass®, Discover Zip®, Visa Contactless®, ExpressPay®, and the like.

A transaction may be conducted by positioning the contactless transaction device 110 a proximate distance from a contactless transaction device reader (not shown) capable of transmitting and receiving a signal via the antenna 116 to/from the microchip 114, such as at a merchant point of sale terminal. Embodiments may also include having a contactless transaction device reader transmit via the antenna 116 a signal to the microchip 114, such as a handshake signal instructing the microchip 114 to start transmitting data that can be used to process the transaction. In one example, when the contactless transaction device 110 conforms to the ISO/IEC 14443 standard, a contactless transaction device reader may send and receive messages via the antenna 116 to/from the microchip 114 via a modulated radio frequency (“RF”) field that has a carrier frequency of approximately 13.56 MHz.

Accordingly, to disable a contactless transaction device one must at least disable the microchip, its transmitting capabilities, and/or its power source. Thus, in the example embodiment illustrated in FIG. 1A, disabling the contactless transaction device 114 may be accomplished by destroying the microchip 114 and/or by destroying the antenna, which may interrupt the device's abilities to receive signals, transmit signals, and/or power the chip, such as is the case for passive transaction devices. In other example embodiments, such as an active or semi-active contactless transaction device including a separate on board power source, the device may also be disabled by destroying the power source and/or interrupting the communication between the power source and the microchip. Any of these disabling techniques, as are more fully described herein, alone or in combination, would render the device inoperable to communicate with a device reader.

FIGS. 1B-1E illustrate additional example contactless transaction devices, having differing shapes and/or configurations, according to embodiments of the invention. These additional embodiments generally operate and function in the same or similar manner as is described with reference to FIG. 1A. For example, FIG. 1B illustrates a contactless transaction device 120 shaped as a miniature card, fob, or keychain, which may be attached to a general purpose ring 126, as shown for illustrative purposes. The contactless transaction device 120 also includes a body 122, at least one microchip 124, and at least one antenna 126. Yet, as illustrated in FIG. 1B, the body 122 in this embodiment may have smaller dimensions for convenient storage as or attached to a keychain, lanyard, fob, or other general purpose ring.

In another example, FIG. 1C illustrates a contactless transaction device 130 configured as a sticker with an adhesive backing 138 able to adhere to any surface, such as a personal item like a card, a cellular phone, a personal digital assistant, a wallet, and the like. The contactless transaction device 130 also includes a body 132, at least one microchip 134, and at least one antenna 136. A contactless transaction device 130 configured as a sticker may have a polymer and/or paper based body 132 having an adhesive backing 138.

In another example, FIG. 1D illustrates a contactless transaction device 140 having a body 142 configured as a flexible wristband, bracelet, or other wearable article. This example contactless transaction device 140 may be worn on one's wrist, ankle, neck, or waist, for example, and constructed from flexible materials such as rubber, other polymers, natural or synthetic fabrics, leather, vinyl, and the like. The contactless transaction device 140 also includes at least one microchip 134 and at least one antenna 136, each of which may be embedded within or otherwise affixed to the body 142.

In another example, FIG. 1E illustrates a passive or semi-passive contactless transaction device 150 including both an inductive antenna 156a and a transmitting antenna 156b in communication with a microchip 154. As described above, some example contactless transaction devices may include two separate antenna, an inductive antenna 156a for energizing the microchip via induction from requesting signals transmitted from a terminal, for example, and a transmitting antenna 156b for transmitting and otherwise communicating with a terminal. Any of the device configurations illustrated or otherwise described herein may include both an inductive antenna 156a and a transmitting antenna 156b.

In another example, FIG. 1F illustrates an active or semi-active contactless transaction device 160 including an on-board power source 160 an antenna 166. The power source 160 is in electrical communication with and powers the microchip 164, as described in more detail herein. The power source 160 may be a battery, a solar cell, or any other suitable power source. Any of the device configurations illustrated or otherwise described herein may include both an inductive antenna 156a and a transmitting antenna 156b.

FIGS. 1A-1F are provided for illustrative purposes as example configurations of a contactless transaction device, but are not intended to be limiting. The illustrated placement, size, and shape of contactless transaction devices and the corresponding components are provided for example purposes only and other placements, sizes, and shapes are possible. Thus, a contactless transaction device take on a different form or configuration than those illustrated herein and still be within the scope of the appended claims.

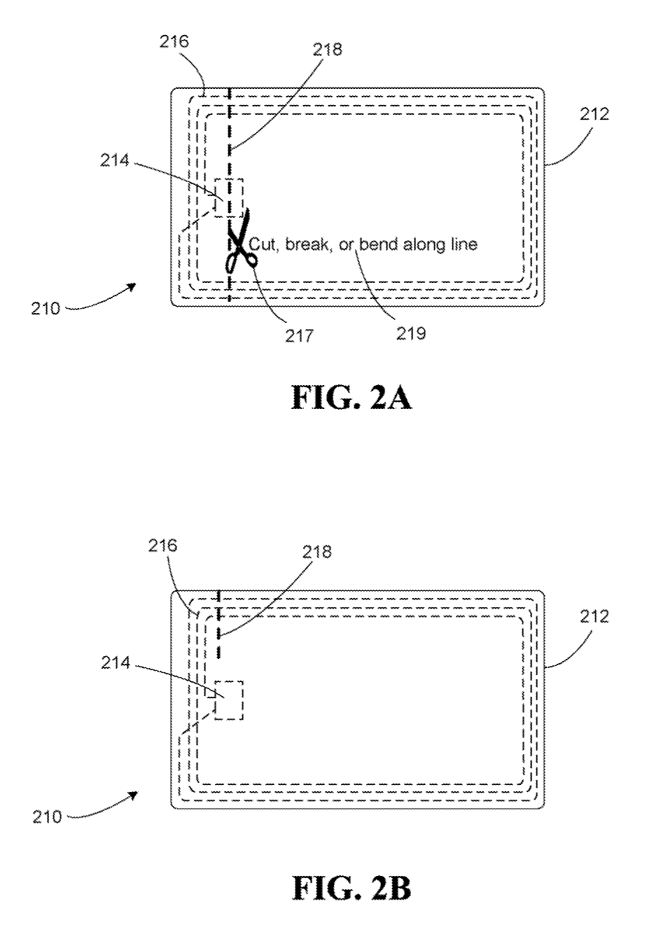

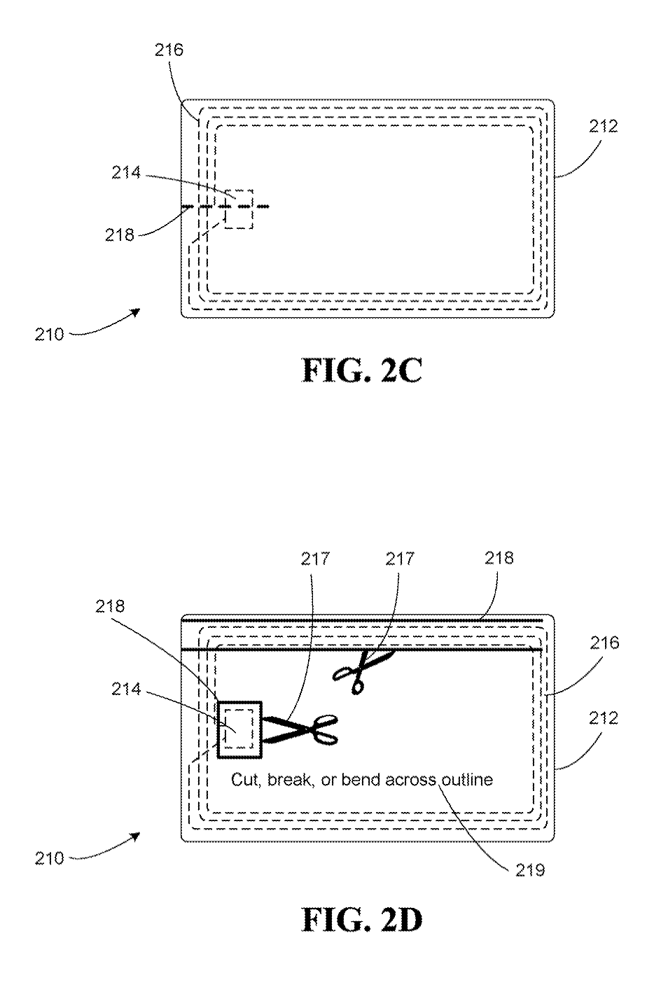

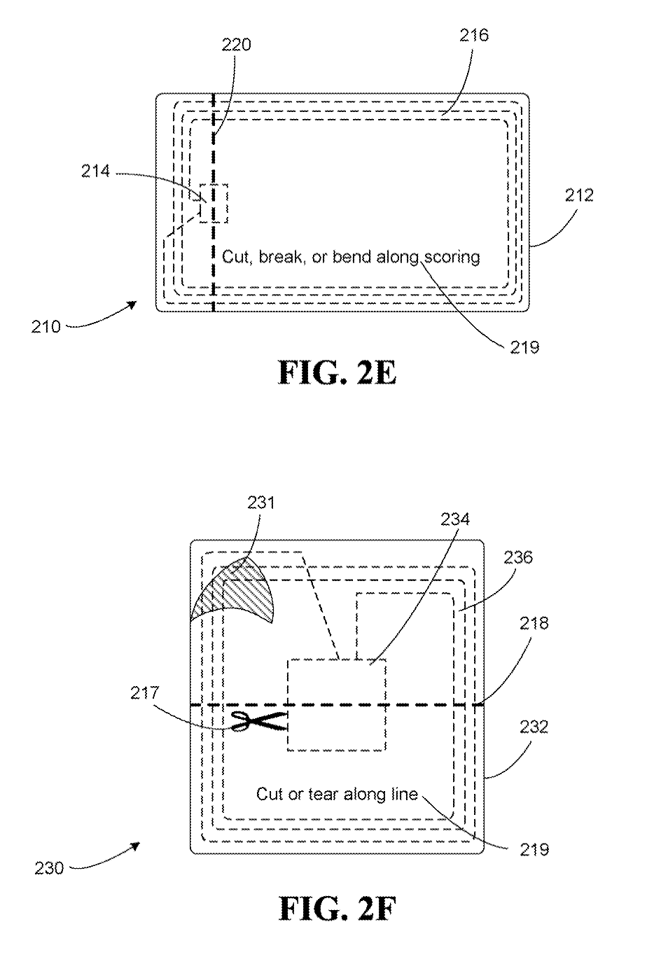

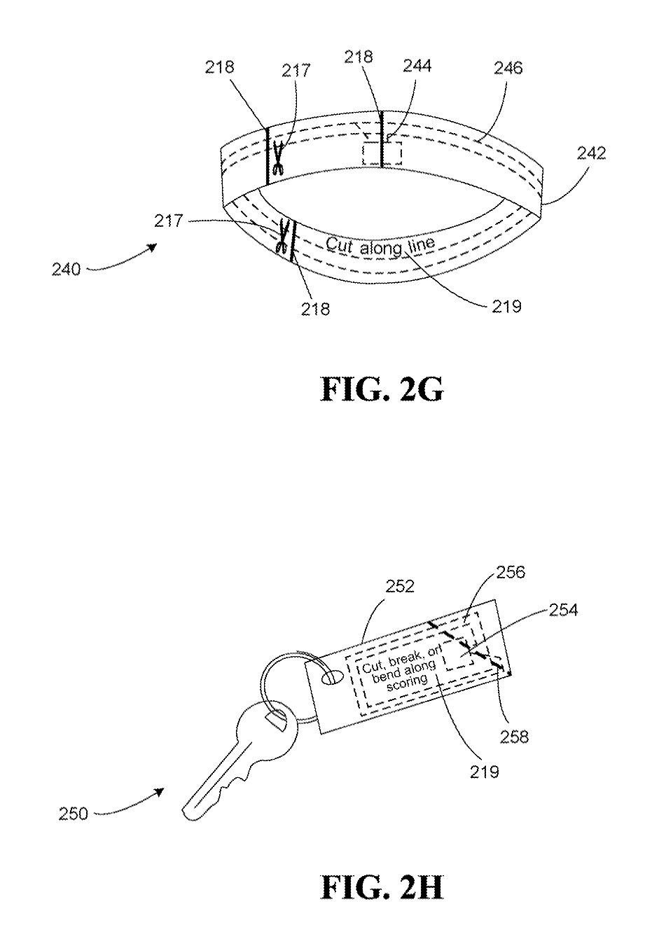

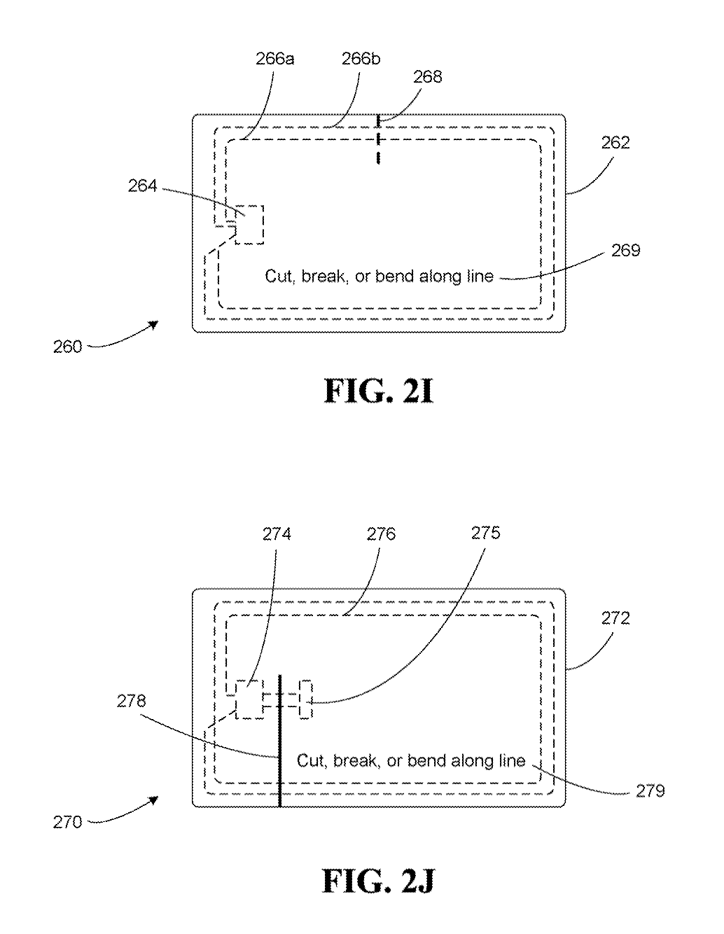

FIGS. 2A-2H illustrate example contactless transaction devices including destruction indicia to indicate a position on the body of the device where a force may be applied to disable the device, so as to render the device inoperable for facilitating electronic transactions such as those described above with reference to FIG. 1. Example contactless transaction devices are provided to illustrate different destruction indicia embodiments in use with various contactless transaction device configurations. It is appreciated that many of the various destruction indicia configurations illustrated on one type of contactless transaction device may be employed on one or more other types, and thus FIGS. 2A-2H are only illustrative and not intended to be limiting.

FIG. 2A shows a contactless transaction device 210 configured in a manner similar to that described with reference to FIG. 1A, having a body 212 with a shape and dimensions similar to a credit card, and at least one microchip 214 and at least one antenna 216 disposed within the body 212. The contactless transaction device 210 further includes one or more destruction indicia 217, 218, 219 displayed on at least one face of its body 212. The destruction indicia 217, 218, 219 may be displayed on a lower face (back) of the body 212, so as to not interfere with other information displayed on the upper face (front) of the card, such as account information, user information, brand information, logos, and the like. However, in other example embodiments, some or all of the destruction indicia 217, 218, 219 may be displayed on the upper face of the body 212.

In one example, the destruction indicia 218 may include a solid or broken line displayed across at least a portion of the body 212. As is shown in FIG. 2A, the destruction indicia 218 represented as a broken line is positioned across the approximate position of both the microchip 214 and the antenna 216. Accordingly, when a force is applied along the destruction indicia 218 represented as a broken line, the card would bend, break, or cut across both the microchip 214 and the antenna 218, destroying the hardware and thus rendering the contactless transaction device 210 inoperable to facilitate an electronic transaction.

In this example embodiment, additional graphic destruction indicia 217 is included, represented as a graphic illustrating how and/or where to apply a force, such as a graphic showing scissors along the position of the body (e.g., the microchip 214 or the antenna 216) to be cut when disabling the contactless transaction device 210. Other example graphic destruction indicia 217 may include, but are not limited to, graphics illustrating: a bending body, a torn body, hands applied at one or more positions on the body, other cutting, bending, or breaking implements, and the like.

This example embodiment also includes written destruction indicia 219 including written, printed, or embossed instructions indicating how and/or where to apply a force when disabling the contactless transaction device. Written destruction indicia 219 may include instructions such as, “Cut, break, or bend along broken line.”, or in certain embodiments, instructions printed in Braille.

Although FIG. 2A illustrates a contactless transaction device 210 including all of the afore-described destruction indicia 217, 218, 219, in example embodiments any combination of the destruction indicia 217, 218, 219 may be provided. For example, FIG. 2B illustrates a contactless transaction device 210 having destruction indicia 218 represented as a broken line across at least a portion of the position of only the antenna 216 in the body 212. A contactless transaction device 210 as illustrated in FIG. 2B instructs a force to be applied across at least one point on the antenna 216, thereby damaging, destroying, or otherwise disabling the operability of the antenna 216, rendering the contactless transaction device inoperable for use in facilitating an electronic transaction. FIG. 2C illustrates another example placement of destruction indicia 218 represented as a broken line across a portion of both the antenna 216 and the microchip 214.

In one example embodiment illustrated in FIG. 2D, a contactless transaction device 210 may include destruction indicia 218 represented as a solid (or broken) line that outlines at least a portion of the microchip 214 and/or the antenna 216. As is shown, the destruction indicia 218 may be a solid line outlining the microchip 214, indicating the position of the microchip 214 and thus indicating a position on the body 212 where a force can be applied to damage, destroy, or otherwise disable the microchip 214. Similarly, the destruction indicia 218 may also include a solid line outlining the antenna 216 (or a portion of the antenna, as is shown), indicating where a force can be applied to damage, destroy, or otherwise disable the antenna 216. In this example embodiment, only a portion of the antenna 216 is outlined, but in other embodiments the entire antenna 216 may be outlined. Also shown are graphic destruction indicia 217, displaying a graphic indicating that a force can be applied across the outline, and written destruction indicia 219, instructing the user to apply a force across the outline (e.g., “Cut, break, or bend across the outline.”).

In another example embodiment illustrated in FIG. 2E, a contactless transaction device 210 may include destruction indicia 220 that is formed by scoring, perforating, or otherwise partially disjoining the body 212 of the device along at least a portion of the microchip 214 and/or the antenna 216. The bottom face of the body 212 may be scored so as to not interfere with other information typically displayed on the upper face. The scoring need not extend entirely through the body 212, but may extend only partially through a face of the body 212, such as only extending partially through the bottom face of the body 212. Scoring serves to weaken the body 212 and to provide an indication that a force may be applied at or near the scoring to damage, destroy, or otherwise disable the microchip 214 and/or the antenna 216. However, the scoring may be formed so as to not substantially weaken the body 212. Scoring indicia that are formed too large or formed too deep into the body 212 may weaken the body 212 such that the hardware may be inadvertently damaged or the body 212 may undesirably flex or bend at the scoring without intentionally applying a disabling force. The scoring may be formed by laser cutting, stamping, pre-molding one or more body layer to include perforations, or any other suitable techniques for scoring, cutting, or creating perforations in the body 212 of a contactless transaction device 210. As illustrated in FIG. 2E, embodiments including scoring destruction indicia 220 may further include additional destruction indicia, such as written destruction indicia 219 instructing the user to apply a force along the scoring (e.g., “Cut, break, or bend across along the scoring.”).

FIG. 2F illustrates another example embodiment of a contactless transaction device 230 configured as a sticker with an adhesive backing 231, as described and illustrated with reference to FIG. 1C. The contactless transaction device 230 includes destruction indicia 217, 218, 219 displayed on the body 232 across at least a portion of the position of the microchip 234 and/or the antenna 236 as previously described. In this embodiment, the destruction indicia 218 is represented as a broken line displayed across all or substantially all of the body 232, extending across the position of the microchip 234 and at least two portions of the antenna 236. Graphic destruction indicia 217 may also be included, represented as a graphic illustrating how and/or where to apply a force, such as a graphic showing scissors along the position of the body (e.g., the microchip 234 or the antenna 236) to be cut, when disabling the contactless transaction device 210. Written destruction indicia 219 may also be included, instructing the user to apply a force along the broken line (e.g., “Cut or tear along the line.”). The written destruction indicia 219 and/or graphic destruction indicia 217 applied to a body 232 configured as a sticker may illustrate and/or indicate destruction techniques that may not be as feasible for other more rigid device bodies, such as tearing, twisting, or wrinkling.

FIG. 2G illustrates another example embodiment of a contactless transaction device 240, configured as a flexible wristband or bracelet (or any other wearable item), as is described and illustrated with reference to FIG. 1D. Destruction indicia 217, 218, 219 may be displayed at one or more points on the body 242 across at least a portion of the position of the microchip 244 and/or the antenna 246. As illustrated in FIG. 2G, the destruction indicia 218 may be represented as a solid or broken line displayed across the position of the microchip 244 and/or across one or more positions of the antenna 246. Graphic destruction indicia 217 (e.g., scissors) and written destruction indicia 219 (e.g., “Cut along line”) may also be displayed on the body 242. Furthermore, because a contactless transaction device 240 configured as a wearable item may be intended to be visually appealing, and/or may include logos or other decorative markings, some or all of the destruction indicia 217, 218, 219 may be applied to the inner surface of the body 242 such that the destruction indicia 217, 218, 219 would not be outwardly visible when worn. Also, in example embodiments, the contactless transaction device 240 configured as a wearable item may be formed from rubber, other polymers, natural or synthetic fabrics, leather, vinyl, and the like; thus, the destruction indicia may be embossed into the body 242 or molded as raised indicia from the body 242, in addition or as an alternative to, printing, impregnating, or otherwise graphically displaying the indicia on the body 242.

FIG. 2H illustrates another example embodiment of a contactless transaction device 250, configured as a miniature card, fob, or keychain, which may be attached to a general purpose ring, as is described and illustrated with reference to FIG. 1B. This example contactless transaction device 250 is illustrated as including destruction indicia 258 formed by scoring, perforating, or otherwise at least partially disjoining the body 252 of the device along at least a portion of the microchip 254 and/or the antenna 256, in a similar manner to that described with reference to FIG. 2E.

FIG. 21 illustrates another example embodiment of a contactless transaction device 260 having an inductive antenna 266a and a transmitting antenna 266b, such as may be used in example passive contactless transaction devices as is described and illustrated with reference to FIG. 1E. This example contactless transaction device 260 is illustrated as including destruction indicia 268 displayed as a solid or broken line at one or more points on the body 262 across at least a portion of the position of the inductive antenna 266a and/or the transmitting antenna 266b, interrupting the reception and transmission capabilities of the microchip 264. Written destruction indicia 269 (e.g., “Cut along line”) may also be displayed on the body 262.

FIG. 2J illustrates another example embodiment of a contactless transaction device 260 having an on board power source 275, such as a battery or solar cell, in electrical communication with the microchip 174, such as may be used in example active or semi-active contactless transaction devices as is described and illustrated with reference to FIG. 1F. This example contactless transaction device 270 is illustrated as including destruction indicia 278 displayed as a solid or broken line at one or more points on the body 272 across at least a portion of the position of the antenna 276 and the electrical connection between the power source 275 and the microchip 274, which both interrupts the reception and transmission capabilities of the microchip 264 and disconnects power from the power supply 275 to the microchip 274. Written destruction indicia 279 (e.g., “Cut along line”) may also be displayed on the body 272.

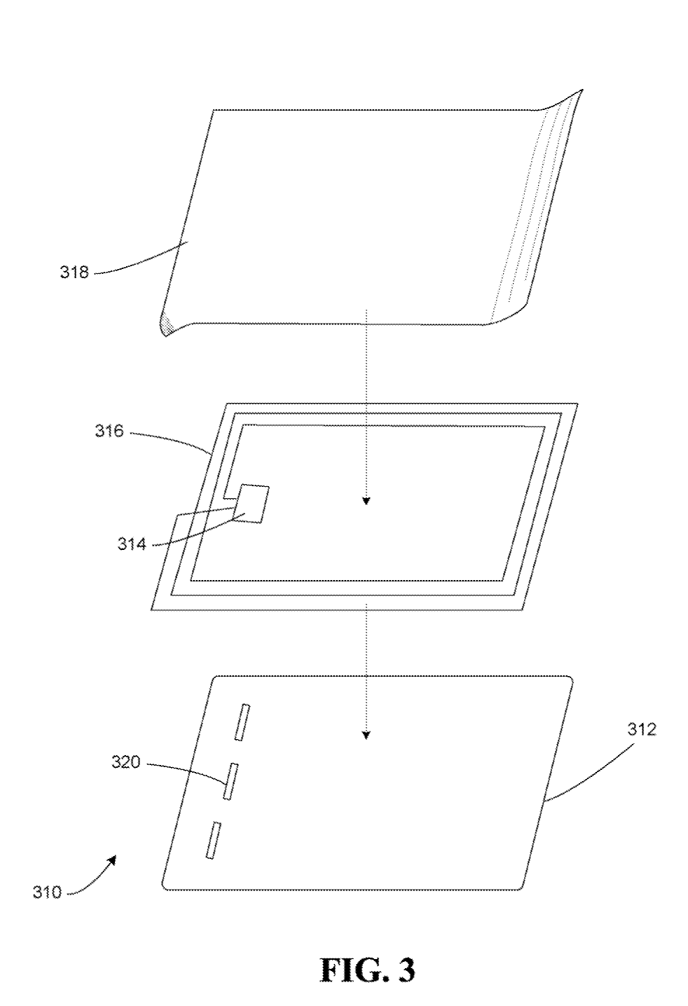

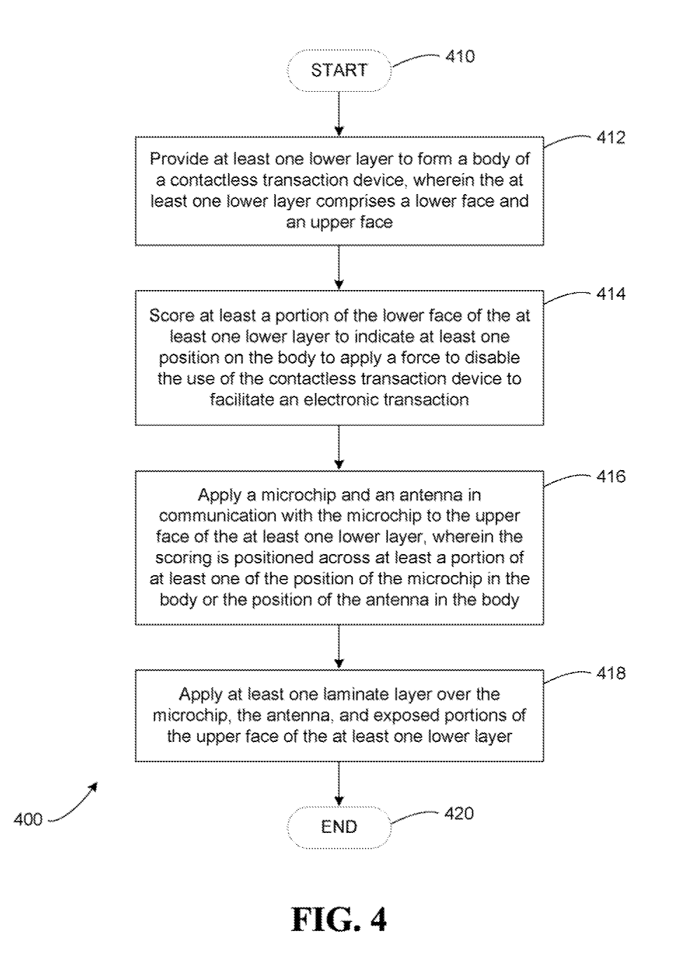

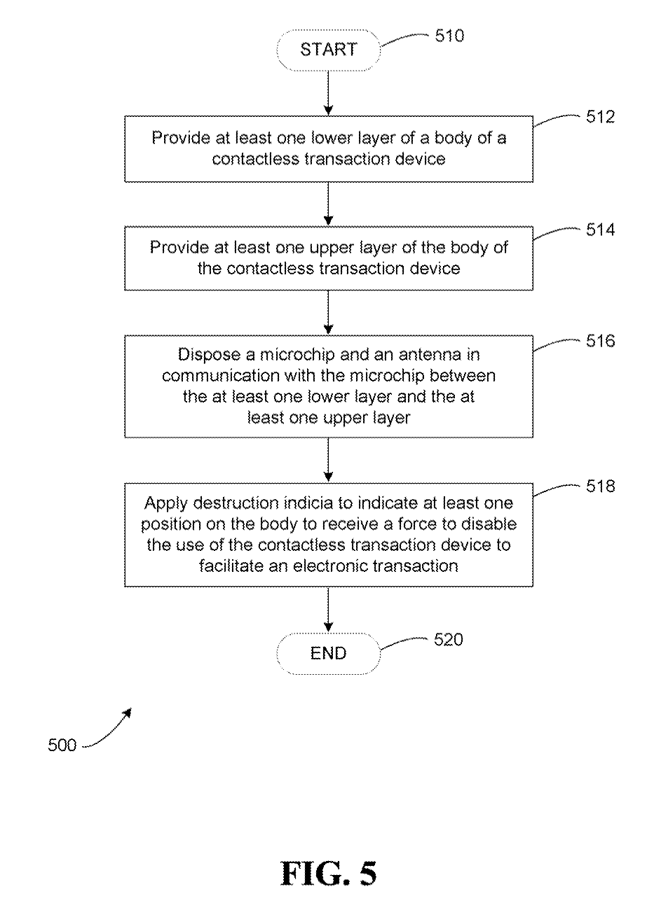

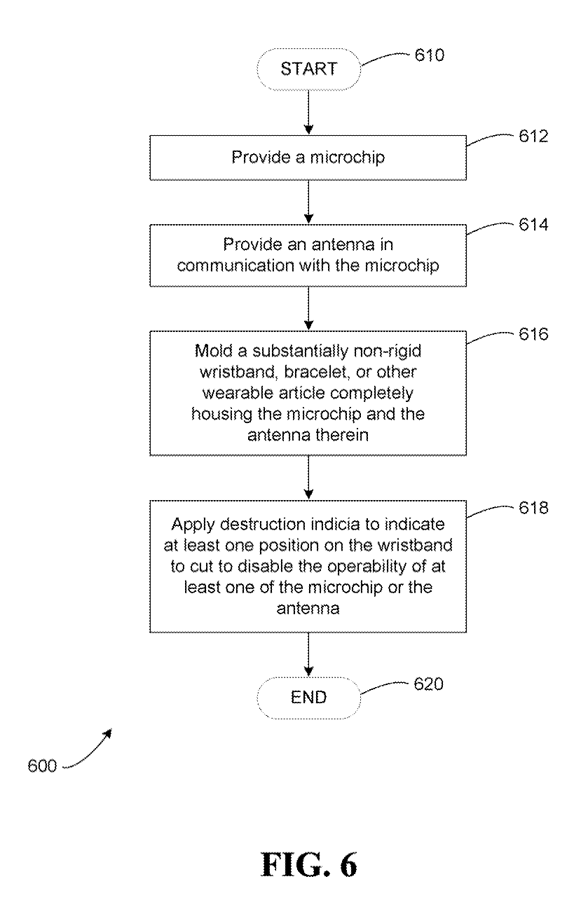

FIGS. 3-6 illustrate example methods by which a contactless transaction device including destruction indicia may be manufactured. FIG. 3 illustrates an exploded plan view of a contactless transaction device 310, having a lower layer 312, an upper layer, 318, at least one microchip 314, at least one antenna 316, and at including one or more destruction indicia 320 on at least one of the layers. FIGS. 4 and 5, providing example flowcharts depicting example methods of manufacturing a contactless transaction device configured as a card, miniature card, sticker, and the like, as illustrated in FIG. 3, will be described with reference to FIG. 3. FIG. 6, providing an example flowchart depicting an example method of manufacturing a contactless transaction device configured as a flexible wristband, bracelet, or any other wearable article, will be described with reference to FIG. 2G.

FIG. 4 provides an example flowchart depicting a method 400 for manufacturing a contactless transaction device 310 having destruction indicia 320 formed by scoring, perforating, or otherwise at least partially disjoining at least one layer of the body of the contactless transaction device 310. The method 400 for manufacturing an example contactless transaction device begins at block 410.

Following block 410 is block 412, in which at least one lower layer 312 is provided. The lower layer 312 may have a lower face and an upper face, the lower face forming the lower side (or back side) of the contactless transaction device 310, and the upper face for receiving the microchip 314 and the antenna 316. In example embodiments, such as a card or miniature card as illustrated in FIGS. 1A and 1B, the lower layer 312 may be formed from rigid or substantially rigid plastics, vinyl, polyvinyl chloride, other polymers, paper, and/or other suitable materials for providing a rigid or semi-rigid device body.

Following block 412 is block 414, in which at least a portion of the lower layer 312 is scored, perforated, or otherwise disjoined, creating destruction indicia 320 to indicate at least one position on the body to apply a force to disable the use of the contactless transaction device from facilitating an electronic transaction. The scoring may be formed by laser cutting, stamping, pre-molding, or any other suitable techniques. When scoring the lower layer 312, the scoring need not extend entirely through the lower layer 312. For example, the scoring may only partially extend into the lower layer 312 without forming a complete aperture therethrough. In example embodiments, the lower layer 312 may be scored, as in block 414, before subsequent assembly of the contactless transaction device 310 to avoid damaging the hardware or otherwise interfering with device assembly. As is further shown in block 416 below, the destruction indicia 320 may be positioned on the lower layer 312 across at least a portion of the intended placement of the microchip 314 and/or the antenna 316.

Following block 414 is block 416, in which at least one microchip 314 and at least one antenna 316 are positioned on the opposite face of the lower layer 312. As illustrated in FIG. 3, at least one of the microchip 314 and/or the antenna 316 approximately align with the destruction indicia 320 such that when a force is applied and the body bends or deforms around the destruction indicia, the microchip 314 and/or the antenna 314 will likewise be deformed and substantially damaged, thus rendering the card inoperable for use in facilitating electronic transactions. FIG. 3 illustrates the destruction indicia 320 intersecting the positions of both the microchip 314 and the antenna 316; however, in other example embodiments, the destruction indicia 320 may be aligned with only the microchip 314 or the antenna 316, or may be aligned with multiple points of the microchip 314 and/or the antenna 316.

Following block 416 is block 418, in which at least one upper or laminate layer 318 is applied over the lower layer 312, securing the microchip 314 and the antenna 316 therebetween. The upper layer 318 may be a flexible, semi-rigid, or rigid laminate, made from plastic, vinyl, polyvinyl chloride, other polymers, paper, and/or other suitable material. The laminate layer 318 may be adhered to the lower layer 312 using adhesive, heat fusion, and/or any other suitable technique. In example embodiments, the upper layer 318 may be at least partially transparent, exposing and making visible some of the components of the contactless transaction device 310.

Following block 418 is block 420, in which the method 400 ends. Assembled, the contactless transaction device 310 of this example includes at least a lower layer 312, an upper layer 318, a microchip 314 and an antenna 316 disposed therebetween, and destruction indicia 320 formed by at least partially scoring the lower layer.

FIG. 5 provides an example flowchart depicting a method 500 for manufacturing a contactless transaction device 310 having destruction indicia 320 graphically or otherwise displayed on the body of the contactless transaction device 310. The method 500 for manufacturing an example contactless transaction device begins at block 510.

Following block 510 is block 512, in which at least one lower layer 312 is provided. The lower layer 312 may have a lower face and an upper face, the lower face forming the lower side (or back side) of the contactless transaction device 310, and the upper face for receiving the microchip 314 and the antenna 316. In example embodiments, such as a card or miniature card as illustrated in FIGS. 1A and 1B, the lower layer 312 may be formed from rigid or substantially rigid plastic, vinyl, polyvinyl chloride, other polymers, paper, and/or other suitable materials, for example, to provide form and rigidity to the device body. In other embodiments, such as a sticker as illustrated in FIG. 1C, the lower layer 312 may be formed from a semi-rigid or non-rigid plastic, vinyl, polyvinyl chloride, other polymers, paper, and/or other suitable materials, for example, to provide a somewhat flexible device body.

Following block 512 is block 514, in which the at least one upper layer 318 is provided. The upper layer 318 be formed from the same or substantially similar materials as described with reference to the lower layer 312.

Following block 514 is block 516, in which at least one microchip 314 and at least one antenna 316 are disposed between the lower layer 312 and the upper layer 318. The lower layer 312 and the upper layer 318 are then adhered using adhesive, heat fusion, or any other suitable technique, retaining the microchip 314 and the antenna 316 therebetween.

Following block 516 is block 518, in which destruction indicia is applied to at least one of the lower layer 312 and/or the upper layer 318 to indicate at least one position on the device to apply a force to disable the use of the contactless transaction device from facilitating an electronic transaction. Whereas FIG. 3 depicts destruction indicia 320 formed by scoring the lower layer 312, in this embodiment the destruction indicia is graphically printed or otherwise applied to the device (not illustrated in FIG. 3), as is described with reference to FIGS. 2A-2D and 2F, for example. The destruction indicia may include a solid or broken line across at least a portion of the position of the microchip 314 and/or the antenna 316, a solid or broken line outlining at least a portion of the microchip 314 and/or the antenna 316, graphic destruction indicia illustrating how and/or where to apply a disabling force, and/or written instruction indicia providing instruction of how and/or where to apply a disabling force. The destruction indicia may be printed, impregnated, embossed, or otherwise applied to the device. It is further appreciated that the destruction indicia may be printed on either or both of the top layer 312 or the bottom layer 318 directly, or on an additional layer applied thereto, such as a laminating layer

Following block 518 is block 520, in which the method 500 ends. Assembled, the contactless transaction device 310 of this example consists of at least a lower layer 312, an upper layer 318, a microchip 314 and an antenna 316 disposed therebetween, and destruction indicia graphically displayed on the lower layer 312 and/or the upper layer 318.

In example embodiments, the contactless transaction device 310 may further include multiple layers, such as an additional laminate layer over the lower layer 312 and/or the upper layer 318, or an additional rigid or semi-rigid layer between the laminate layer and the microchip 314 and antenna 316. In example embodiments, additional indicia may be displayed on the contactless transaction device 310, such as account information, logos, trademarks, service marks, cardholder information, instructional information, legal information, a signature strip, and the like. The additional indicia may be displayed on the upper (front) face and/or the lower (back) face of the device. The additional indicia may be printed, impregnated, embossed, or otherwise displayed on the device. Some example embodiments may further include a magnetic stripe to store and facilitate the transmission of account information, card information, issuer information, user information, and the like via a magnetic reader.

FIG. 6 provides an example flowchart depicting a method 600 for manufacturing a contactless transaction device 240 configured as a flexible wristband, bracelet, or any other wearable article, as illustrated and described with reference to FIG. 2G, that includes destruction indicia 217, 218, 219 graphically or otherwise displayed on the body 242 of the device. The method 600 for manufacturing an example contactless transaction device begins at block 610.

Following block 610 are blocks 612 and 614, in which at least one microchip 244 and at least one antenna 246 in communication with the microchip 244 are provided, respectively.

Following block 614 is block 616, in which a flexible wristband or other wearable article is formed as the body 242 of the contactless transaction device 240, housing the microchip 244 and the antenna 246 therein. The body 242 may be formed by molding the body 242 around the microchip 244 and the antenna 246, laminating the microchip 244 and the antenna 246 between multiple layers, or other suitable techniques, as are known. The body 242 may be formed from rubber, other polymers, natural or synthetic fabrics, leather, vinyl, and the like.

Following block 616 is block 618, in which destruction indicia 217, 218, 219 is applied to at least one position the body 242 of the device, indicating at least one position on the device to apply a force to disable the use of the contactless transaction device 240 from facilitating an electronic transaction. As described in more detail with reference to FIG. 2G, the destruction indicia 217, 218, 219 may include some or all of: destruction indicia 218 represented as a solid or broken line displayed across the position of the microchip 244 and/or across one or more positions of the antenna 246, graphic destruction indicia 217 (e.g., scissors), and/or written destruction indicia 219 (e.g., “Cut along line”). The destruction indicia 217, 218, 219 may be embossed into the body 242 or molded as raised indicia from the body 242, in addition or as an alternative to, printing, impregnating, or otherwise graphically displaying the indicia on the body 242. In example embodiments, the destruction indicia 217, 218, 219 may be applied to the inner surface of the body 242 such that the destruction indicia 217, 218, 219 would not be outwardly visible when worn.

Following block 618 is block 620, in which the method 600 ends. Assembled, the contactless transaction device 240 of this example consists of a flexible body 242 formed as a wristband, bracelet, or other wearable article that houses a microchip 244 and an antenna 246 and includes destruction indicia 217, 218, 219 displayed on the body 242 of the device.

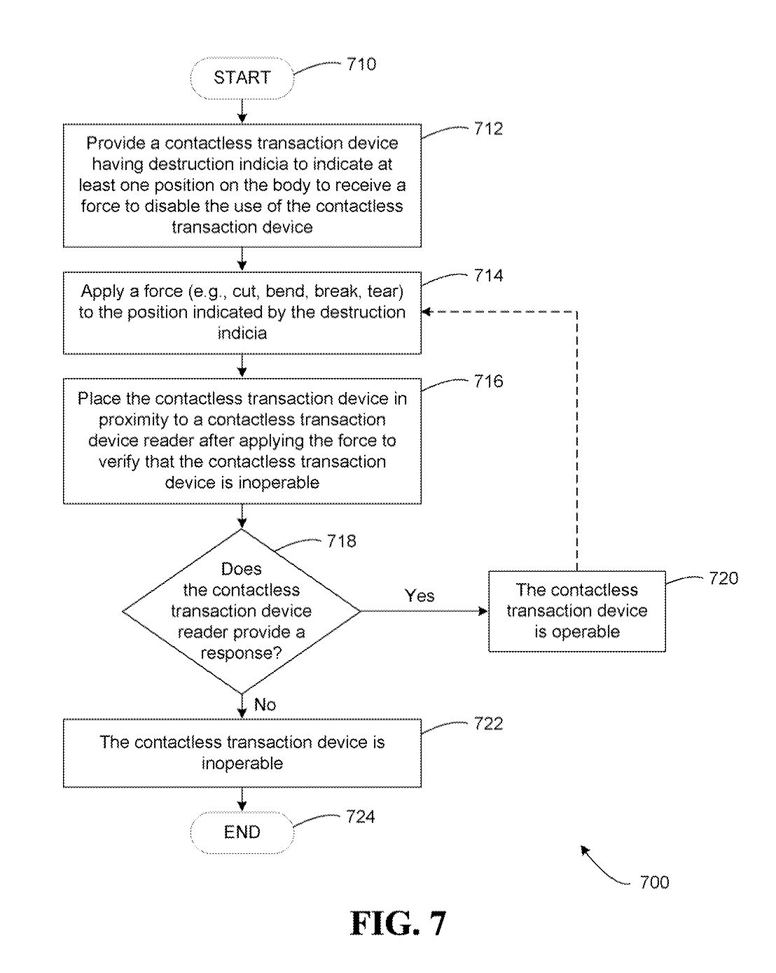

FIG. 7 provides an example flowchart depicting a method 700 for disabling a contactless transaction device including destruction indicia, such as those described herein, according to one example embodiment. The method 700 for disabling an example contactless transaction device begins at block 710.

Following block 710 is block 712, in which a contactless transaction device having destruction indicia is provided. The contactless transaction device may be configured in any manner, such as those described and illustrated with reference to FIGS. 1A-1D. The contactless transaction device may include destruction indicia that indicates at one or more positions on the device where a force may be applied to disable the use of the contactless transaction device for facilitating an electronic transaction, such as is described and illustrated with reference to FIGS. 2A-2H.

Following block 712 is block 714, in which a force is applied to the contactless transaction device according to the destruction indicia displayed thereon. The destruction indicia may indicate that a force can be applied across the position of the microchip and/or the antenna, thus damaging the microchip and/or the antenna when applying the force. As described herein, the destruction indicia may be provided as: a solid or broken line displayed across the position of the microchip and/or across one or more positions of the antenna, graphic destruction indicia illustrating how and/or where to apply a disabling force (e.g., a graphic of scissors), and/or written destruction indicia providing instructions on how and/or where to apply a disabling force (e.g., “Bend, break, cut, or tear along line”). Example disabling forces to be applied may include, but are not limited to, cutting force, a bending force, a deforming force, a twisting force, a lateral force, a longitudinal force, or a tearing force.

Following block 714 is block 716, in which the contactless transaction device is placed in proximity to a contactless transaction device reader to determine if the application of the force was effective in disabling the device. Typical contactless transaction device readers provide visual and/or audible indication of successful wireless communication with a contactless transaction device. Example indications may include, but are not limited to, a light, a light color change, beeping, buzzing, an alarm, spoken indications, and the like. Thus, if the contactless transaction device is effectively disabled, then no audible, visual, and/or any other indication of successful communication is expected.

Following block 716 is decision block 718, in which it is determined if the contactless transaction device reader provided a response when the contactless transaction device is placed in proximity thereto. If a response is provided, then block 720 follows, in which it is determined that the contactless transaction device is not disabled. If the device is not disabled, the method 700 may optionally return to block 714, in which a disabling force is again applied. If a response is not provided at block 718, then block 722 follows, in which it is determined that the contactless transaction device is disabled.

Following block 722 is block 724, in which the method 700 ends after the device is determined that the contactless transaction device is disabled responsive to the force applied at or along the destruction indicia.

Additionally, it is to be recognized that, while the invention has been described above in terms of one or more preferred embodiments, it is not limited thereto. Various features and aspects of the above described invention may be used individually or jointly. Although the invention has been described in the context of its implementation in a particular environment and for particular purposes, its usefulness is not limited thereto and the invention can be beneficially utilized in any number of environments and implementations. Furthermore, while the methods have been described as occurring in a specific sequence, it is appreciated that the order of performing the methods is not limited to that illustrated and described herein, and that not every step described and illustrated need be performed. Accordingly, the claims set forth below should be construed in view of the full breadth and spirit of the invention as disclosed herein.

1. A contactiess transaction device operable to facilitate an electronic transaction, the device comprising:
a body;
a microchip integrated with the body;
an antenna integrated with the body and in communication with the microchip; and
at least one of an induction loop or a power source in communication with the microchip;
wherein the body comprises destruction indicia to indicate at least one position of the induction loop or the power source to receive a force to permanently disable use of the contactless transaction device for facilitating an electronic transaction.

2. The contactless transaction device of claim 1, wherein the body comprises one of: a substantially rigid card, a semi-rigid card, a sticker, a substantially non-rigid wristband, or a substantially rigid fob.

3. (canceled)

4. The contactless transaction device of claim 1, wherein the destruction indicia further comprises instructions to apply the force along a solid or broken line.

5-8. (canceled)

9. The contactless transaction device of claim 1, wherein the destruction indicia comprises scoring of the body across at least a portion of at least one of the position of the induction loop or the power source in the body.

10. The contactless transaction device of claim 9, wherein the destruction indicia further comprises instructions to break the body by applying the force at the scoring.

11. The contactless transaction device of claim 1, wherein the force to disable use of the contactless transaction device to facilitate an electronic transaction comprises one of: a cutting force, a bending force, a deforming force, a twisting force, a lateral force, a longitudinal force, or a tearing force.

12. The contactless transaction device of claim 1, wherein the destruction indicia comprises at least one of: (i) a solid or broken line across at least a portion of the position of the induction loop in the body, (ii) a solid or broken line indicating the approximate location of at least a portion of the induction loop in the body, (iii) scoring of the body across at least a portion of the position of the induction loop in the body, or (iv) a solid or broken line outlining at least a portion of the induction loop in the body.

13. The contactless transaction device of claim 1, wherein the power source is in electrical communication with the microchip through an electrical connection, and wherein the destruction indicia comprises at least one of: (i) a solid or broken line across at least a portion of the position of the power supply in the body, (ii) a solid or broken line indicating the approximate location of at least a portion of the power supply in the body, (iii) scoring of the body across at least a portion of the position of the power supply in the body, (iv) a solid or broken line across at least a portion of the position of the electrical connection in the body, (v) a solid or broken line indicating the approximate location of at least a portion of the electrical connection in the body, (vi) scoring of the body across at least a portion of the position of the electrical connection in the body, or (vii) a solid or broken line outlining at least a portion of the power source in the body.

14. A method for manufacturing a destructible contactless transaction device operable to facilitate an electronic transaction, the method comprising:
providing at least one lower layer of a body of the contactless transaction device;
providing at least one upper layer of the body of the contactless transaction device;
disposing a microchip, an antenna in communication with the microchip, and at least one of an induction loop or a power source in communication with the microchip between the at least one lower layer and the at least one upper layer; and
applying destruction indicia to indicate at least one position of the induction loop or the power source to receive a force to permanently disable use of the contactless transaction device for facilitating an electronic transaction.

15. The method of claim 14, wherein the at least one lower layer comprises a lower face and an upper face, and wherein applying destruction indicia comprises:
prior to disposing the microchip, the antenna, and at least one of an induction loop or a power source between the at least one lower layer and the at least one upper layer, scoring at least a portion of the lower face of the at least one lower layer to indicate at least one position on the body to receive a force, wherein the scoring is positioned across at least a portion of at least one of the position of the induction loop or the power source in the body.

16. The method of claim 15, wherein providing at least one upper layer comprises applying at least one laminate layer over the microchip, the antenna, at the induction loop or the power source, and exposed portions of the upper face of the at least one lower layer.

17. The method of claim 15, wherein the scoring comprises scoring at least partially through the at least one lower layer.

18. The method of claim 15, wherein scoring comprises at least one of laser cutting or stamping the at least one lower layer.

19. The method of claim 14, wherein the lower layer comprises at least one of a substantially rigid layer or a semi-rigid layer.

20. The method of claim 14, wherein applying the destruction indicia comprises at least one of: (i) printing, (ii) embossing, or (iii) impregnating the destruction indicia.

21. (canceled)

22. A method of disabling the device in claim 14, comprising applying a force to the at least one position indicated by the destruction indicia to disable use of the contactless transaction device for facilitating an electronic transaction.

23. The method of claim 22, further comprising placing the contactless transaction device in proximity to a contactless transaction device reader after applying the force to verify that the contactless transaction device is inoperable.

24. A contactless transaction device operable to facilitate an electronic transaction, the device comprising:
a body;
a microchip integrated with the body;
an antenna integrated with the body and in communication with the microchip; and
at least one of an induction loop or a power source in communication with the microchip;
wherein the body comprises destruction indicia on the body to indicate a position to receive a force to permanently disable use of the contactless transaction device for facilitating an electronic transaction, wherein the destruction indicia comprises a solid or broken line outlining at least a portion of at least one of the microchip, the antenna, or the induction loop or power source in the body.

25. The contactless transaction device of claim 24, wherein the destruction indicia further comprises instructions to apply the force intersecting the solid or broken line.
